(19) United States
(12) Patent Application Publication
(10) Pub. No.: US 2008/0126442 A1
(43) Pub. Date: May 29, 2008

(54) Architecture for back up and/or recovery of electronic data

(76) Inventors: Pavel Cisler, Los Gatos, CA (US); Steve Ko, San Francisco, CA (US); Peter McInerney, Cupertino, CA (US); Robert Ulrich, San Jose, CA (US); Eric Weiss, San Francisco, CA (US)

Correspondence Address: FISH & RICHARDSON P.C., PO BOX 1022, MINNEAPOLIS, MN, 55440-1022, US

(21) Appl. No.: 11/499,880

(22) Filed: Aug. 4, 2006

(51) Int. Cl. G06F 17/30; G06F 3/00

(52) U.S. Cl. 707/204; 715/700; 711/E12.005

(57) ABSTRACT

Systems and methods are provided including a backup system architecture for performing backup operations. In one implementation, a method is provided. A backup process is initialized on a device. An initial backup is performed for the device including storing data from the device on a first storage device. The stored data has a format corresponding to a file system structure of the device.

### RELATED APPLICATIONS

This application is generally related to the following jointly owned and co-pending patent applications, each incorporated herein by reference in its entirety:
U.S. patent application Ser. No. ______, for “Managing Backup of Content,” filed Aug. 4, 2006;
U.S. patent application Ser. No. ______, for “User Interface for Backup Management,” filed Aug. 4, 2006;
U.S. patent application Ser. No. ______, for “Navigation of Electronic Backups,” filed Aug. 4, 2006;
U.S. patent application Ser. No. ______, for “Application-Based Backup-Restore of Electronic Information,” filed Aug. 4, 2006;
U.S. patent application Ser. No. ______, for “Searching a Backup Archive,” filed Aug. 4, 2006;
U.S. patent application Ser. No. ______, for “Conflict Resolution in Recovery of Electronic Data,” filed Aug. 4, 2006;
U.S. patent application Ser. No. ______, for “System for Multi-Device Electronic Backup,” filed Aug. 4, 2006;
U.S. patent application Ser. No. ______, for “System for Electronic Backup,” filed Aug. 4, 2006;
U.S. patent application Ser. No. ______, for “Restoring Electronic Information,” filed Aug. 4, 2006;
U.S. patent application Ser. No. ______, for “Links to a Common Item in a Data Structure,” filed Aug. 4, 2006;
U.S. patent application Ser. No. ______, for “Event Notification Management,” filed Aug. 4, 2006;
U.S. patent application Ser. No. ______, for “Consistent Back Up of Electronic Information,” filed Aug. 4, 2006.

### TECHNICAL FIELD

The disclosed implementations relate generally to storing and restoring data.

### BACKGROUND

A hallmark of modern graphical user interfaces is that they allow a large number of graphical objects or items to be displayed on a display screen at the same time. Leading personal computer operating systems, such as Apple Mac OS@, provide user interfaces in which a number of windows can be displayed, overlapped, resized, moved, configured, and reformatted according to the needs of the user or application. Taskbars, menus, virtual buttons and other user interface elements provide mechanisms for accessing and activating windows even when they are hidden behind other windows.

With the sophisticated tools available, users are encouraged not only to create and save a multitude of items in their computers, but to revise or otherwise improve on them over time. For example, a user can work with a certain file and thereafter save its current version on a storage device. The next day, however, the user could have had second thoughts about the revisions, or could have come up with new ideas, and therefore opens the file again.

The revision process is usually straightforward if the user wants to add more material to the file or make changes to what is there. But it is typically more difficult for a user who has changed his/her mind about changes that were previously made and wants the file back as it was once before. Application programs for word processing typically let the user “undo” previous edits of a text, at least up to a predefined number of past revisions. The undo feature also usually is configured so that the previously made revisions must be undone in reverse chronological order; that is, the user must first undo the most recently made edit, then the second-most recent one, and so on. If the user saves and closes the document and thereafter opens it again, it might not be possible to automatically undo any previous edits.

### SUMMARY

Systems and methods are provided including a backup system architecture for performing backup operations. A backup daemon can perform backup operations and store the backup date as a file system hierarchy. Additionally, a interface can be provided for setting back up preferences, for example, scheduling of backup operations, particular applications to include in a backup, and a selection of particular backup devices to store backups.

In general, in one aspect, a method is provided. A backup process is initialized on a device. An initial backup is performed for the device including storing data from the device on a first storage device. The stored data has a format corresponding to a file system structure of the device.

Implementations of the method can include one or more of the following features. The method can further include performing an incremental backup. Performing an incremental backup can include identifying changed data on the device from the initial backup and storing the changed data and data representing a current file system hierarchy of the backup data, where the data representing the current file system hierarchy includes links to data of the initial backup. Initializing a backup process can include loading the backup process at system startup and running the backup process continuously as a background process. Performing an initial backup can include identifying one or more storage devices for storing the initial backup.

Identifying changed data can include monitoring for events indicating a change to data on the device. Identifying changed data can include comparing data on the device with the data of the initial backup. Identifying changed data can include identifying a change according to one or more rules defining change events. Performing the incremental backup can further include monitoring system resources identifying system inactivity and initiating the incremental backup when system inactivity is identified. The incremental backup can be performed according to a schedule. The incremental backup can be performed in response to a change in data on the device.

In general, in one aspect, a system is provided. The system includes a graphical user interface. The graphical user interface is configured to present a preferences menu include general preferences and backup device preferences. The backup device preferences including a destination location for a backup. The general preferences include information associated with backup scheduling.

Implementations of the system can include one or more of the following features. The preferences menu can include scheduling preferences for scheduling a backup operation. The general preferences can include a plurality of applications for selection as included in a backup operation.

In general, in one aspect, a method is provided. A backup system is initiated. One or more preferences are selected for backup operations. One or more backup operations are performed according to the identified preferences, the backup operations generate a backup having stored data corresponding to a file system structure.

Implementations of the method can include one or more of the following features. Selecting one or more preferences can include selecting one or more applications to be included in the generated backup, selecting a schedule for performing the backup operations, or selecting a particular storage device of one or more storage devices to store the generated backup. The one or more storage devices can be external storage devices. A storage device can be a remote storage device. The file system structure of the stored backup can be a hierarchical file system.

In general, in one aspect, a method is provided. One or more criteria are defined for capturing a state of a view of a user interface. A backup daemon is used to capture the state of the view in accordance with the criteria. A captured view is stored on an external storage device. A prompt is received to suspend presentation of a current view and present the captured view. The captured view is reinstated into the current view of the user interface.

The details of the various aspects of the subject matter described in this specification are set forth in the accompanying drawings and the description below. Other features, aspects, and advantages of the invention will become apparent from the description, the drawings, and the claims.

### BRIEF DESCRIPTION OF THE DRAWINGS

FIG. 1 is a block diagram of an example of an architecture for modifying a user interface view in a display environment.

FIG. 2 is a block diagram of an example of an architecture for backing up and restoring application files.

FIG. 3 shows an example of a desktop user interface for accessing the time machine settings dialog.

FIG. 4A shows an example of a time machine settings dialog.

FIG. 4B shows another example of a time machine settings dialog for setting general preferences.

FIG. 5 shows an example of a time machine settings dialog for setting backup storage device options.

FIG. 6 shows an example of a time machine settings dialog over which a pop-up window for a particular storage device is displayed.

FIG. 7 shows an example of a time machine settings dialog over which a pop-up window for a newly detected storage device is displayed.

FIG. 8 shows an example of a time machine settings dialog for setting backup storage device options in which two devices are available.

FIG. 9 shows an example of a time machine settings dialog over which a pop-up window for a particular storage device is displayed.

FIG. 10 shows is a flow diagram of a method illustrating a backup process scenario.

### DETAILED DESCRIPTION

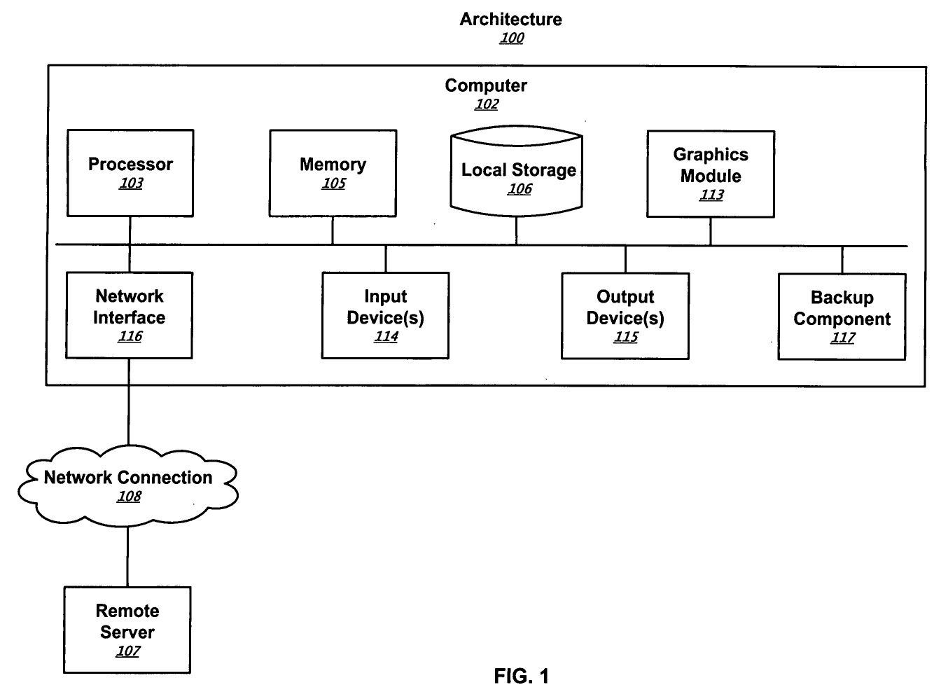

FIG. 1 is a block diagram of an architecture 100 for capturing at least one earlier version of a user interface view and allowing a user to initiate a restoration based on it. As used herein, a view refers to an item, element or other content, capable of being stored and/or retrieved in an interface, that can be subjected to a backup operation by a backup component 117 (to be described later). For example, a user interface view can contain any number of icons, files, folders, application state information and/or machine state information, etc. The architecture 100 includes a personal computer 102 communicatively coupled to a remote server 107 via a network interface 116 and a network 108 (e.g., local area network, wireless network, Internet, intranet, etc.). The computer 102 generally includes a processor 103, memory 105, one or more input devices 114 (e.g., keyboard, mouse, etc.) and one or more output devices 115 (e.g., a display device). A user interacts with the architecture 100 via the input and output devices 114, 115.

The computer 102 also includes a local storage device 106 and a graphics module 113 (e.g., graphics card) for storing information and generating graphical objects, respectively. The local storage device 106 can be a computer-readable medium. The term “computer-readable medium” refers to any medium that includes data and/or participates in providing instructions to a processor for execution, including without limitation, non-volatile media (e.g., optical or magnetic disks), volatile media (e.g., memory) and transmission media. Transmission media includes, without limitation, coaxial cables, copper wire, fiber optics, and computer buses. Transmission media can also take the form of acoustic, light or radio frequency waves.

While modifications of a user interface view are described herein with respect to a personal computer 102, it should be apparent that the disclosed implementations can be incorporated in, or integrated with, any electronic device that has a user interface, including without limitation, portable and desktop computers, servers, electronics, media players, game devices, mobile phones, email devices, personal digital assistants (PDAs), embedded devices, televisions, other consumer electronic devices, etc.

Systems and methods are provided for modifying an interface view (e.g., a user interface view). The systems and methods can be stand alone, or otherwise integrated into a more comprehensive application. In the materials presented below, an integrated system and method for modifying a user interface view is disclosed. However, one of ordinary skill in the art will recognize that the engines, methods, processes and the like that are described can themselves be an individual process or application, part of an operating system or application, a plug-in or the like.

In one implementation, the systems and methods can be implemented as one or more plug-ins that are installed and run on the personal computer 102. The plug-ins are configured to interact with an operating system (e.g., MAC OS® X, WINDOWS XP, LINUX, etc.) and to perform the various functions, as described with respect to the Figures. A system and method for modifying a user interface view can also be implemented as one or more software applications running on the computer 102. Such a system and method can be characterized as a framework or model that can be implemented on various platforms and/or networks (e.g., client/server networks, wireless networks, stand-alone computers, portable electronic devices, mobile phones, etc.), and/or embedded or bundled with one or more software applications (e.g., email, media player, browser, etc.).

The computer 102 includes the backup component 117 (e.g., a backup daemon) that allows for the storage of versions of the computer's files or other items (e.g., restoring a view including past state of a file, application, application data, parameters, settings, and the like), for example within the local storage 106 or in an external storage repository. In one implementation, the backup component 117 also allows a user to select any of the stored versions and use it to initiate a restoration of that version in the computer.

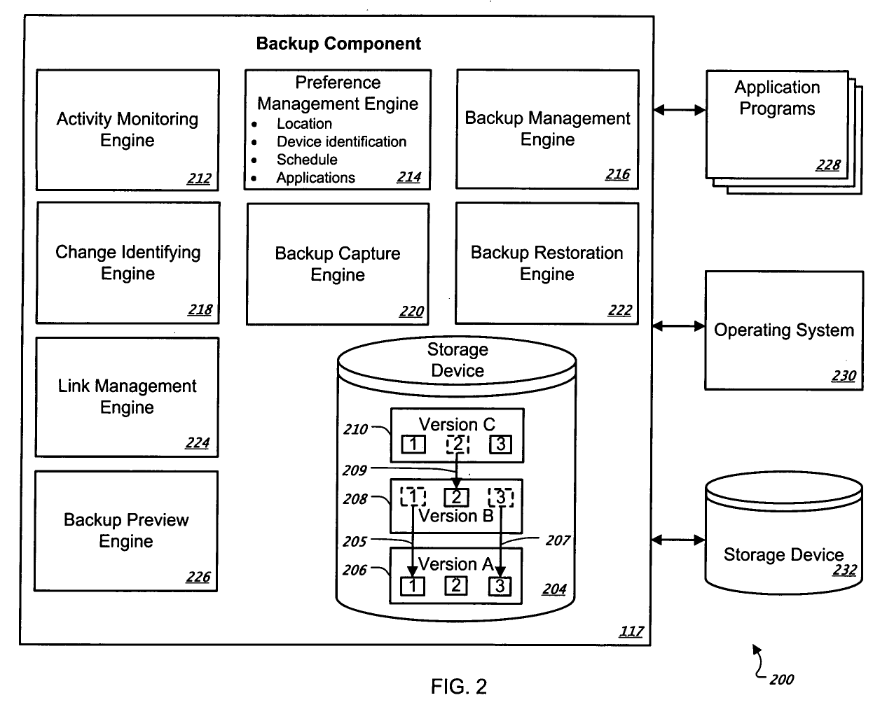

FIG. 2 is a block diagram of an exemplary architecture 200 for enabling the back up and restoration of data (e.g., application files, application data, settings, parameters or the like), such as those associated with a set of application programs 228. Backup component 117 provides back up and restoration capability for the system. Many different items or elements can be the subject of a backup operation in the system. For example, folders, files, items, information portions, directories, images, system or application parameters, playlists, e-mail, inbox, application data, address book, a state of an application or state of the system, preferences (e.g., user or system preferences), and the like all can be candidates for archiving. Other types of candidates are also possible. In this example, the backup component 117 includes a storage device 204 (e.g., a local storage device) and a storage device 232 (e.g., an external storage device). Versions can be stored on either of them. Any number of local and/or external storage devices can be used by the backup component 117 for storing versions.

In one implementation, the backup component 117 runs as a background task on an operating system 230, that is not visible to the user. The backup component 117 can be capable of running across multiple user accounts.

The backup component 117 includes an activity monitoring engine 212. In one implementation, the activity monitoring engine 212 monitors for changes within an application view (e.g. files) that are targeted for a backup operation. A change can also include the addition of new files or data or the deletion of the same.

In one implementation, the activity monitoring engine 212 is capable of discerning between a substantive change (e.g. the text within a document has been modified) and a non-substantive change (e.g. the play count within an iTunes playlist has been updated, or several changes that cancel each other out) through its interaction with the application programs 228. The activity monitoring engine 212 can, for example, create a list of modified elements to be used when a backup event is eventually triggered. In one implementation, the activity monitoring engine 212 can monitor the system for periods of inactivity. The activity monitoring engine 212 can then trigger a backup event during a period of time in which the backup operation will not cause a system slowdown for an active user. Alternatively, the activity monitoring engine 212 triggers a backup event a time in which the user is not actively using the system (e.g., idle time).

A preference management engine 214 specifies some operating parameters of the backup component 117. In one implementation, preference management engine 214 contains user-specified and/or system default application parameters for the backup component 117. These can include settings for the details of capturing and storing the earlier versions. For example, the preference management engine 214 could determine the frequency of a backup capture, the storage location for the backup versions, the types of files, data, or other items that are eligible for backup capture, and the events which trigger a backup capture (periodic or event-driven, etc.).

In one implementation, the preference management engine 214 can detect that a new storage device is being added to the system and prompt the user as to whether it should be included as a backup repository. Files and other items can be scheduled for a backup operation due to location (e.g. everything on the C: drive and within D:/photos), a correlation with specific applications (e.g. all pictures, music, e-mail, address book and system settings), a user selection/identification of specific items, or a combination of strategies. Different types of items can be scheduled to be stored on different devices or on different segments of a storage device during a backup operation. In one implementation, the backup component 117 stores the versions with a format corresponding to a file system structure. In one implementation, the file system structure allows the user to navigate data in the stored version.

A backup management engine 216 coordinates the collection, storage, and retrieval of view versions performed by the backup component 117. For example, the backup management engine 216 can trigger the activity monitoring engine 212 to watch for activities that satisfy a requirement specified in the preference management engine 214.

A change identifying engine 218 locates specific views or other items within to determine if they have changed. The change identifying engine 218 can be capable of discerning a substantive change from a non-substantive change, similar to the example described above for the activity monitoring engine 212. In one implementation, the change identifying engine 218 traverses a target set of files, data, or other items, comparing a previous version to the current version to determine whether or not a modification has occurred.

A backup capture engine 220 locates files, data, or other items that are to be backed up. The backup capture engine 220 can invoke the activity monitoring engine 212 and/or the change identifying engine 218, for example, to generate a capture list. The backup capture engine 220 can then store copies of these elements in one or more targeted storage repositories. The backup capture engine 220 can track multiple versions of each item included in the backup repository.

The backup component 117 includes a backup restoration engine 222 to restore previous views (e.g. versions of files, data, or other items). In one implementation, the backup restoration engine 222 provides a user interface (e.g., a graphical user interface) where a user can select the item(s) to be restored.

The backup component 117 can include a link management engine 224 that coordinates the links between version sets. In such an implementation, the backup component 117 can manage multiple versions of an item using links. There will now be described an example of how links can be coordinated between versions. Within the storage device 204 a first backup archive 206 (“Version A”) is a backup version of an item. Version A contains three separate archived items labeled 1, 2 and 3. The Version A corresponds to the contents of the items at a particular point in time. After version A is captured, a user in this example changes the item 2 somewhat, for example by editing a document. Later, another capture event creates a second backup archive 208 (“Version B”) of the item (e.g., a capture event recognized by the activity monitoring engine 212 or the change identifying engine 218 results in the generation of a second version by the backup capture engine 220). Items 1 and 3 are identical to those in Version A. The link management engine 224 can be used to create a link 205 from the item 1 in Version B to the item 1 in Version A as part of the generation process. Accordingly, only one copy of item 1 is required to be stored within the storage device 204 at the time Version B is created. Similarly, a link 207 connects item 3 in Version B to the item 3 in Version A. The item 2 in Version B, in contrast, is not identical to the item 2 in Version A and is therefore stored in Version B with its current contents. A user can access any of the items in the Version A, or any of the items listed in the Version B, or all of them. In one implementation, the user may not be able to detect that some items are accessed directly (e.g., the item 2 accessed through Version B), and some are accessed using a link (e.g., the item 1 in Version A accessed using the link in Version B).

At a later time, a user modifies information associated with the items 1 and 3. A third backup archive 210 (“Version C”) can then be generated (by for example, the backup capture engine 220). Here, the item 1 in Version C is different from the item 1 in Version A and the modified contents of item 1 are therefore stored in Version C. Accordingly, there is no link equivalent to the link 205 from this item to the item 1 in Version A. Similarly, the modified contents of the item 3 are stored in Version C. However, the item 2 has not been changed since Version B. The link management engine 224 can create a link 209 from the item 2 in Version C to the item 2 in Version B as part of the version archive process. In this example, it is seen that the link management engine 224 manages links across multiple version sets. That is, each of Version B and Version C contains one or more links to an earlier version where appropriate. Other configurations of items, item entries and links can be used.

A backup preview engine 226 is configured to provide a preview of at least one of the captured earlier versions. The preview can allow a user to peruse the contents of a backup copy of a view (e.g., a file, data, or file set) before opting to restore the element (e.g. file(s)) using the backup restoration engine 222.

The archived copies can be compressed and/or encrypted. An example of a compression technique is the ZIP file format for data compression and archiving. An example of an encryption technique is the RSA algorithm for public key encryption. Other compression techniques or encryption techniques can be used.

In one implementation, if multiple users make use of the backup component 117 on a single system, each user can select to keep separate archives. Access to an individual user's archives can be password protected or otherwise held in a secure manner. In one implementation, the archive storage structure mimics a typical file system structure, such that the archived versions can be perused using a standard file system viewing utility.

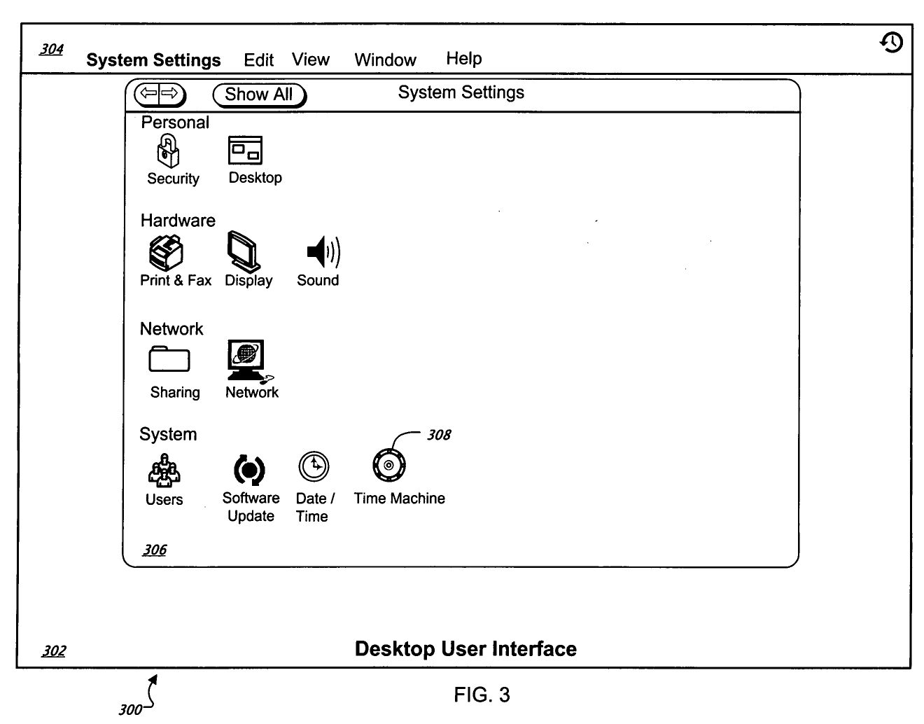

There will now be described some exemplary user interfaces that can be used in managing and using a system for backing up versions of views (e.g., including files, data, or other items). In one implementation, the user interfaces can be generated by an operating system and the backup component 117. FIG. 3 is a screen shot 300 depicting a desktop user interface 302. In this example, the system where the user interface 302 is generated is provided with a component that captures and manages versions of views (including items such as files, folders, etc.). That component is here referred to as a “time machine”. For example, the time machine could be part of the backup component 117.

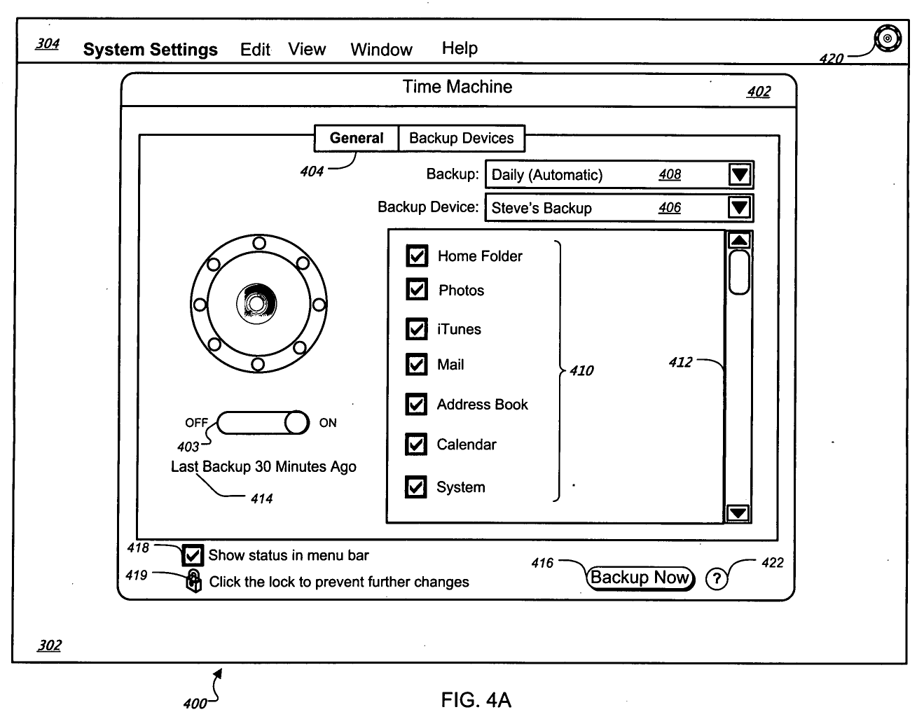

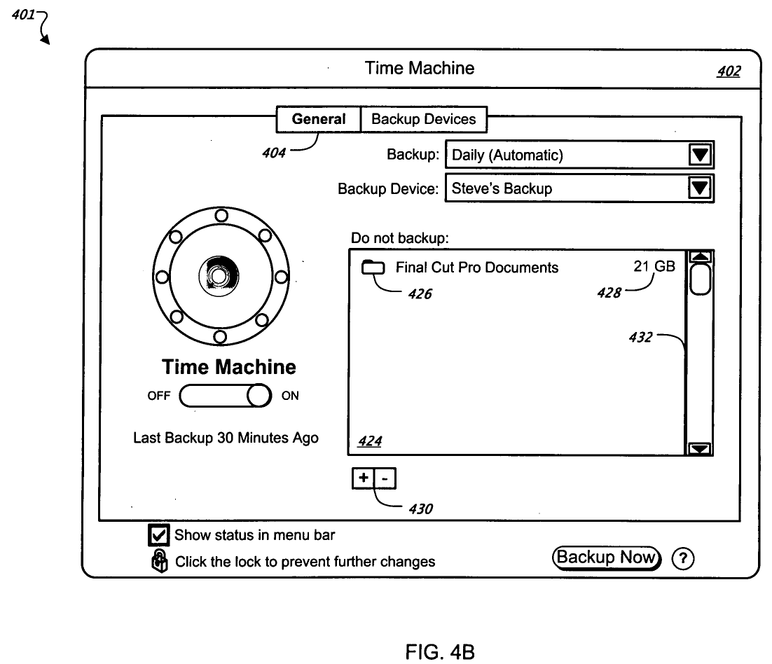

A menu bar 304 within the desktop user interface 302 allows access to the system settings dialog 306. A time machine icon 308 is available within the system settings dialog 306. A user can select the time machine icon 308 to open a time machine settings dialog such as any of the ones portrayed within FIG. 4A-B. Thus, the time machine icon 308 is here accessible in the context where the user can configure other system aspects, such as hardware peripherals, system utilities, network connectivity, etc. In other implementations, the time machine engine could be accessible within the desktop user interface 302 itself, through an applications menu or file listing, or as part of the functionality included within another application, etc.

FIG. 4A shows a screen shot 400 depicting an example of a time machine settings dialog 402 within the desktop user interface 302. In one implementation, the dialog 402 is generated by the preference management engine 214 (FIG. 2). A general settings tab 404 is selected. A user can select a device name within a drop-down menu 406 to establish a backup location. A drop-down menu 408 can be used to set the frequency of making backups (e.g. every day, every week, every other week, every month, etc.). In another implementation, a time of day or other granularity setting can be available. In one implementation, a setting can allow the user to request that the utility run during a typically inactive period, such as overnight. In one implementation, an event-driven trigger can be specified, such as having the backup utility run upon system start-up. In another example of an event-driven trigger, the time machine could be set to back up when there has been activity relating to the item that is to be backed up. In one implementation, the backup operation can be set to run in periods of inactivity when there could be less user demand on system performance. In other implementations, the backup operation can be set to run according to one or more rules, programmatic instructions, or otherwise scheduled.

A user can select from a set of applications 410 which type(s) of data is eligible for inclusion in a backup. The applications list can contain specific products or applications (e.g. iTunes) and/or general categories (e.g. photos, address book, e-mail inbox). In one implementation, each application name is individually selectable. For example, within an internet browser application, the user can set the bookmarks and personal settings to be backed up but not the history or cookies. One implementation could allow a user to select specific disk drives, folders, and/or files for a backup operation. A scroll bar 412 allows the user to view additional applications or candidates that would otherwise not fit within the viewing window. In one implementation, all system data is included in the backup unless excluded by the user. In another implementation, the user can have more than one archive, each respective archive can include backup data associated with different system data or application data.

A message block 414 alerts the user as to the date and time of the last backup event. In one implementation, this information is obtained from the backup capture engine 220 (FIG. 2). The user can select a slide bar control 403 to switch the backup operations on or off. A user can select a backup now button 416 to trigger a backup event. In one implementation, the backup now button 416 calls the backup capture engine 220 (FIG. 2) to initiate a capture event using the settings provided within the time machine settings dialog 402.

If a checkbox 418 is selected, the time machine engine provides a status icon 420 within the menu bar 304 of the desktop user interface 302. The status icon 420 can alter in appearance depending upon the time machine engine's status, e.g. when the time machine engine is disabled, when it is actively backing up files, or when it is in standby mode, etc. The status icon 420 can provide the user with an additional method of accessing the time machine settings dialog 402. In one implementation, a different type of status indicator could be used, or a different way of initiating it could be provided.

If a lock icon 419 is selected, the time machine engine backup configuration is essentially locked into place until the icon 419 is selected again. For example, selecting the lock icon 419 in the settings dialog 402 can ensure daily (automatic) backup operations are performed using a backup device (e.g., “Steve's backup device”) as the storage medium until the lock icon 419 is selected, thus unlocking the current backup configuration.

A user can select a help button 422 to open a help dialog regarding the time machine engine. The help dialog can be presented within the time machine settings dialog 402 or in a separate pop-up window, for example. In another implementation, a mouse over of individual controls within the time machine settings dialog 402 provides the user with a brief description of that control's functionality.

FIG. 4B shows a screen shot 401 depicting another example of the time machine settings dialog 402 in which a general settings tab 404 is selected. In contrast to the example in FIG. 4A where the user can select application(s) to be backed up, the current example lets the user specify content that is not to be backed up. A display window 424 contains sets of information specifying the content(s) that should not be backed up. In this scenario, the default action would be for the time machine to back up all of the information (i.e. all that is stored on the system, storage drive, or storage segment, etc.) unless otherwise instructed within the display window 424. The display window 424 here contains a folder 426 named “Final Cut Pro Documents”. The folder 426 has an associated size 428 of 21 GB. An add/delete key 430 allows the user to remove or include items within the display window 424. In one implementation, the user can activate the “+” side of the add/delete key 430 to generate a file system browser to allow the user to select one or more files, folders, etc. to add to the display window 424. In one implementation, by highlighting the folder 426 and activating the “−” side of the add/delete key 430, the user can remove the folder 426 from the display window 424. A scroll bar 432 allows the user to view additional listings (files, folders, application data sets, etc.) that would not otherwise fit within the viewing window.

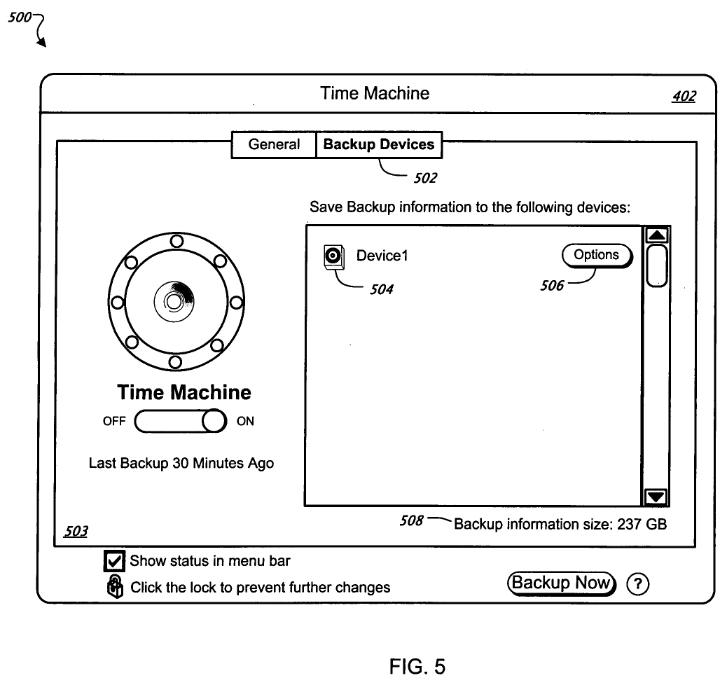

FIG. 5 shows a screen shot 500 depicting an example of the time machine settings dialog 402 in which a backup devices tab 502 is selected. A backup devices view 503 allows the user to select one or more repositories for storing archived items. In this example, a first device 504 is the only option presently available to the user. A user can select an options button 506 associated with the first device 504 to view a settings dialog for this device. In one implementation, selection of the options button 506 triggers the display of another pop-up window. An information field 508 informs the user of the present size of the archived information. In this example, the backup information is taking up 237 gigabytes of space.

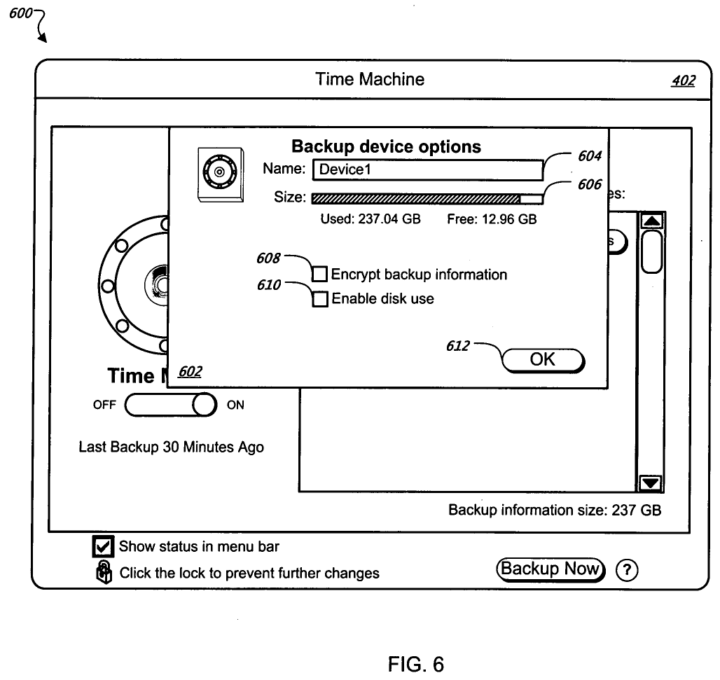

For the next example, the user selects the options button 506 (FIG. 5). As shown in FIG. 6, a screen shot 600 contains a pop-up window 602 overlaying the time machine settings dialog 402. The pop-up window 602 displays options relating to the first device 504. An information field 604 contains the storage device name, in this example “Device 1”. A bar graph 606 illustrates the amount of free space available on the first device 504. According to the text beneath the bar graph 606, 237.04 gigabytes of memory has been used, and 12.96 gigabytes of memory is free on the first device 504.

A user can select a checkbox 608 to have the corresponding backup information encrypted. For example, in one implementation, this causes the existing archives within the associated backup device to be placed in an encrypted format. In another implementation, only the archives generated after the time of selecting the checkbox 608 will be generated in an encrypted format. In one implementation, the backup capture engine 220 (FIG. 2) creates the encrypted copies for the archives. A user can select a checkbox 610 to enable the backup component 117 to use the first device 504 as an archive storage location. In one implementation, the name field 604 can be user-selectable to define the storage location in greater detail. For example, a particular segment or segments of a backup device could be selected rather than the entire device. A user can select an OK button 612 to close the popup window 602 and return to the time machine settings dialog 402.

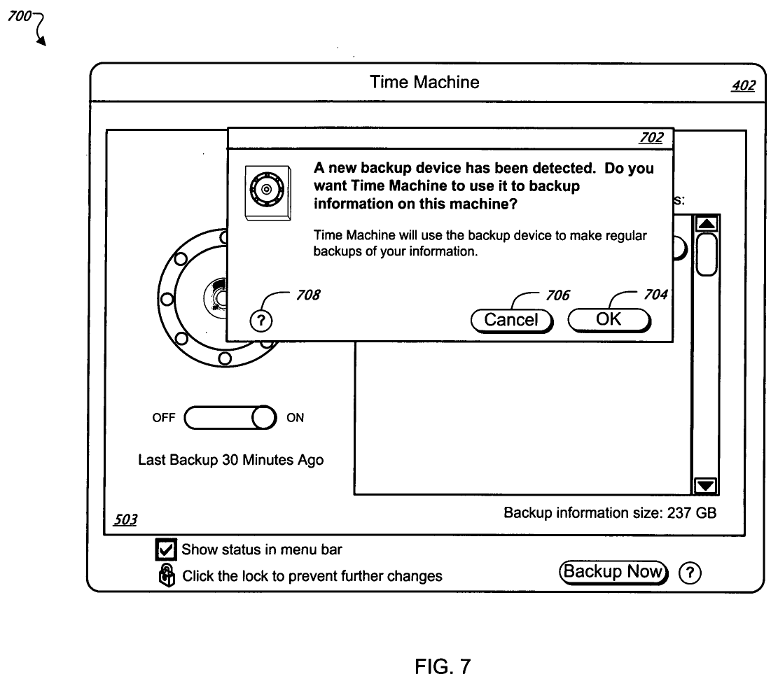

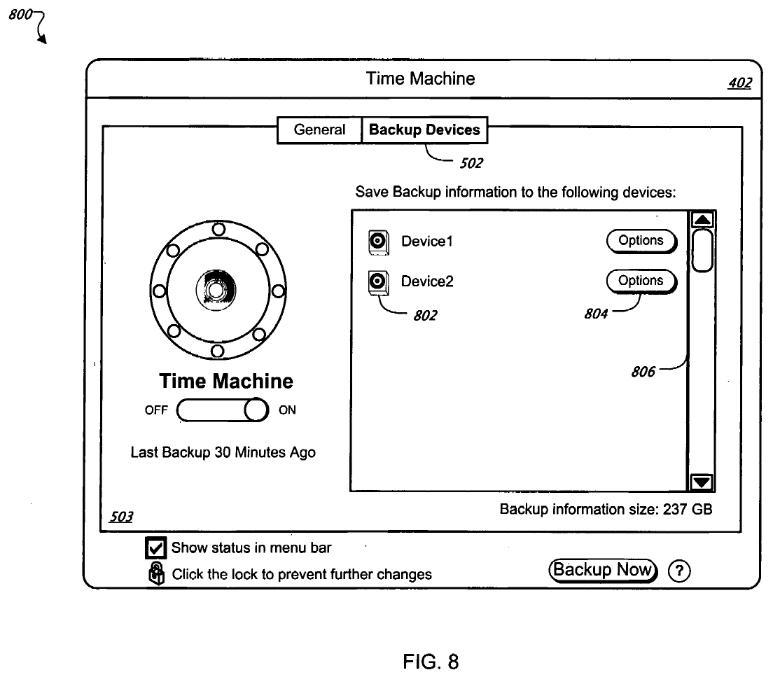

A system that is configured for performing information backup can register that a new device becomes available. FIG. 7 shows a screen shot 700 depicting an example of the time machine settings dialog 402 overlaid by a pop-up window 702 alerting the user to this situation. The message within the pop-up window 702 prompts the user to select whether or not the time machine engine should use this new device for storing archives. The user can select an OK button 704 to accept the device as an additional archive storage repository. In one implementation, user selection of the OK button 704 adds the device information to the options list in preference management engine 214. Additionally, user selection of the OK button 704 could add the device to the backup devices view 503 within the time machine settings dialog 402 (see FIG. 8).

The user can select a cancel button 706 to not have the time machine engine use the new device. A help button 708 provides the user with more information regarding the addition of the new device. For example, the help button 708 can cause detailed information regarding the device to be displayed within the pop-up window 702. In another implementation, when a new storage device is detected by the backup component 117, the new storage device automatically appears in the backup devices view 503 (FIG. 5). In this example, the user can access the device options in the manner illustrated in FIG. 6 to enable the device as a backup archive repository or to modify or enter specific settings for the device, to name two examples.

FIG. 8 shows a screen shot 800 depicting an example of the time machine settings dialog 402 in which a backup devices tab 502 is selected, as in the example in FIG. 5. Here, a second device 802 has been added. In one implementation, the second device 802 could have been detected by the system and selected by the user via an automatic detection pop-up window (FIG. 7). A user can select an options button 804 associated with the second device 802 to view a settings dialog for this device. In one implementation, selection of the options button 804 triggers the display of another pop-up window.

Any number of backup devices can be used by the time machine engine. A scroll bar 806 allows a user to access additional storage devices that would otherwise not fit into the viewing window. In another implementation, a user is presented with side-by-side displays of storage devices in use and storage devices presently available. In this example, the user could add or remove archive repositories, e.g. by dragging and dropping individual storage device listings. Other methods of selecting archive repositories are possible.

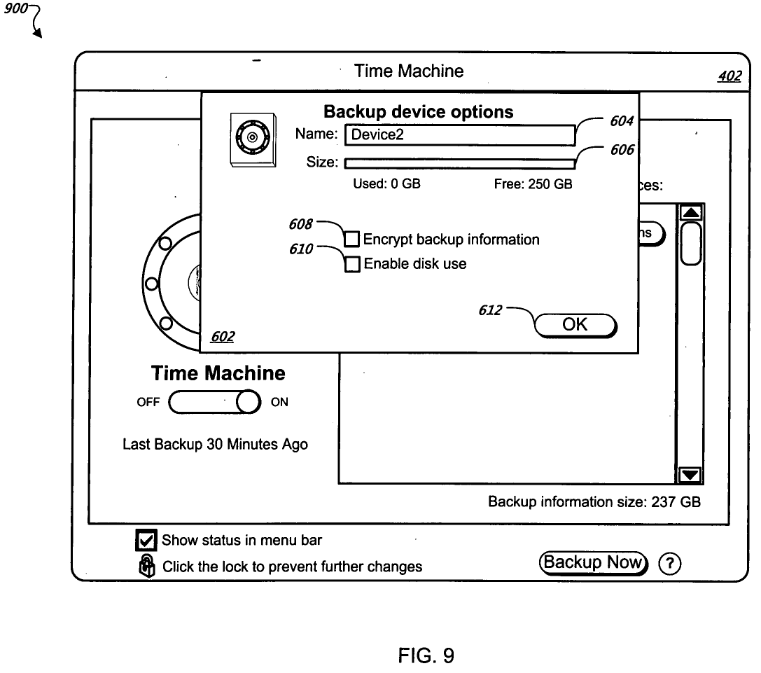

Next in this example, the user selects the options button 804 (FIG. 8). As shown in FIG. 9, a screen shot 900 containing a pop-up window 602 overlaying the time machine settings dialog 402 can then be presented. The pop-up window 602 displays options relating to the second device 802. An information field 604 contains the storage device name, in this example “Device2”. A bar graph 606 illustrates the amount of free space available on the second device 802. According to the text beneath the bar graph 606, zero gigabytes of memory have been used, and 250 gigabytes of memory are free on the second device 802.

A user can select a checkbox 608 to have the corresponding backup information encrypted. In one implementation, encryption can be an application-wide setting rather than an individual device setting. A user can select a checkbox 610 to enable the backup component 117 to use the second device 802 as an archive storage location. In one implementation, the name field 604 can be user-selectable to define the storage location in greater detail. For example, the user can specify that the second device 802 is a secondary storage archive, and that the first device 504 (FIG. 5) is to be used as the primary archive space. In this manner, once the first device 504 is full, the time machine engine will switch to the second device 802 for archive storage.

In one implementation, the user can associate different storage devices with different archive contents. For example, the user can select that mail, address book, calendar, and system applications archives be stored on the first device 504, and that the second device 802 should contain the photos and iTunes archives. One benefit of this option could be that very large data volumes are stored on an external storage device while the smaller files are stored locally. A user can select an OK button 612 to close the popup window 602 and return to the time machine settings dialog 402.

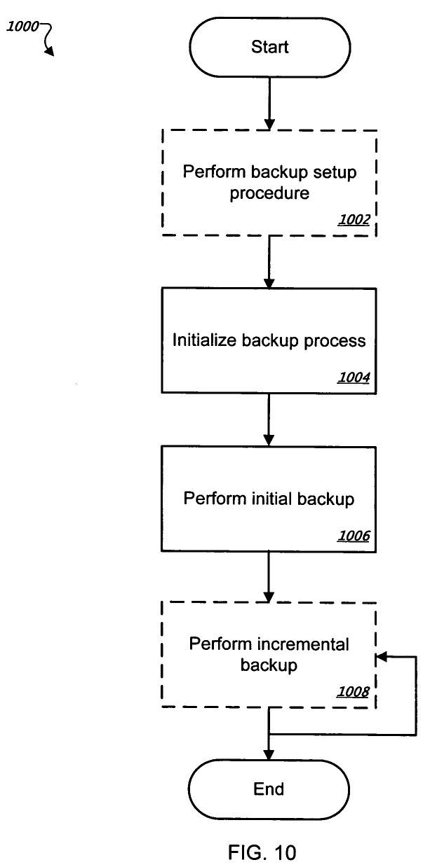

FIG. 10 is a flow diagram of a method 1000 illustrating a backup process scenario. The method 1000 can be performed in a computer system with a storage device, to name one example. In one implementation, the method includes a backup application setup procedure (step 1002). The setup procedure could be available through a graphical user interface (GUI), for example, and could involve recording settings that are entered by the user. During the backup setup procedure, the user could be allowed to designate a schedule for running the backup process, one or more storage devices to use for archival storage, a set of items to be backed up, etc.

During backup process initialization (step 1004), the backup application is loaded onto the system. An initialization of the backup process (step 1004) can involve loading the backup process at system startup and running the backup process continuously as a background task. For example, the backup process could run outside of the user space and could occur without requiring user interaction.

The method involves performing an initial backup operation (step 1006). During the initial backup operation, the application identifies one or more storage devices for storing the initial backup archives and then stores data from the device on the storage device(s). The stored data can have a format corresponding to a file system structure of the device. For example, this can provide that the stored data can be perused, for instance, using a standard file system navigation application.

Optionally, the backup application could perform an incremental backup operation (step 1008). An incremental backup operation can capture changes in the data since the time of the initial backup process. In one implementation, the backup application can identify data on the device that has changed since the initial backup operation. The backup application can monitor for events indicating a change to data on the device. The backup application can compare data on the device with the data of the initial backup to discover changes. There could be rules defining change events. For example, an updated timestamp might not be construed as a significant enough modification to define it as a change of the data for the purposes of triggering the archiving of a new backup copy.

A variety of events could trigger an incremental backup operation. For example, the backup application can monitor system resources to identify a period of system inactivity during which it can initiate an incremental backup operation. Alternatively, the incremental backup could be performed according to a schedule (e.g. daily, weekly, etc.). An incremental backup operation could, in another circumstance, be performed in response to a change in data on the device. For example, a user can designate that an incremental backup operation be automatically triggered whenever the backup application recognizes a change in a particular data set.

An incremental backup event can include storing the changed data and data representing a current file system hierarchy of the backup data, where the data representing the current file system hierarchy includes links to data of the initial backup. In this manner, if a particular data set is unchanged since the initial backup event, only one copy of that data will be stored. The incremental back up can create a link to the location of the data within the initial backup archive. Any number of incremental backup events can occur, with each event building upon the linked hierarchical file system structure of backup data sets. The method 1000 could end upon occurrence of an event, such as a predefined ending time, a user input, or system shutdown.

In the above description, for purposes of explanation, numerous specific details are set forth in order to provide a thorough understanding. It will be apparent, however, to one skilled in the art that implementations can be practiced without these specific details. In other instances, structures and devices are shown in block diagram form in order to avoid obscuring the disclosure.

In particular, one skilled in the art will recognize that other architectures and graphics environments can be used, and that the examples can be implemented using graphics techniques and products other than those described above. In particular, the client/server approach is merely one example of an architecture for providing the functionality described herein; one skilled in the art will recognize that other, non-client/server approaches can also be used. Some portions of the detailed description are presented in terms of algorithms and symbolic representations of operations on data bits within a computer memory. These algorithmic descriptions and representations are the means used by those skilled in the data processing arts to most effectively convey the substance of their work to others skilled in the art. An algorithm is here, and generally, conceived to be a self-consistent sequence of steps leading to a desired result. The steps are those requiring physical manipulations of physical quantities. Usually, though not necessarily, these quantities take the form of electrical or magnetic signals capable of being stored, transferred, combined, compared, and otherwise manipulated. It has proven convenient at times, principally for reasons of common usage, to refer to these signals as bits, values, elements, symbols, characters, terms, numbers, or the like.

It should be borne in mind, however, that all of these and similar terms are to be associated with the appropriate physical quantities and are merely convenient labels applied to these quantities. Unless specifically stated otherwise as apparent from the discussion, it is appreciated that throughout the description, discussions utilizing terms such as “processing” or “computing” or “calculating” or “determining” or “displaying” or the like, refer to the action and processes of a computer system, or similar electronic computing device, that manipulates and transforms data represented as physical (electronic) quantities within the computer system's registers and memories into other data similarly represented as physical quantities within the computer system memories or registers or other such information storage, transmission or display devices.

An apparatus for performing the operations herein can be specially constructed for the required purposes, or it can comprise a general-purpose computer selectively activated or reconfigured by a computer program stored in the computer. Such a computer program can be stored in a computer readable storage medium, such as, but is not limited to, any type of disk including floppy disks, optical disks, CD-ROMs, and magnetic-optical disks, read-only memories (ROMs), random access memories (RAMs), EPROMs, EEPROMs, magnetic or optical cards, or any type of media suitable for storing electronic instructions, and each coupled to a computer system bus.

The algorithms and modules presented herein are not inherently related to any particular computer or other apparatus. Various general-purpose systems can be used with programs in accordance with the teachings herein, or it could prove convenient to construct more specialized apparatuses to perform the method steps. The required structure for a variety of these systems will appear from the description. In addition, the present examples are not described with reference to any particular programming language. It will be appreciated that a variety of programming languages can be used to implement the teachings as described herein. Furthermore, as will be apparent to one of ordinary skill in the relevant art, the modules, features, attributes, methodologies, and other aspects can be implemented as software, hardware, firmware or any combination of the three. Of course, wherever a component is implemented as software, the component can be implemented as a standalone program, as part of a larger program, as a plurality of separate programs, as a statically or dynamically linked library, as a kernel loadable module, as a device driver, and/or in every and any other way known now or in the future to those of skill in the art of computer programming. Additionally, the present description is in no way limited to implementation in any specific operating system or environment.

The subject matter described in this specification can be implemented as one or more computer program products, i.e., one or more modules of computer program instructions encoded on a computer readable medium for execution by, or to control the operation of, data processing apparatus. The instructions can be organized into modules (or engines) in different numbers and combinations from the exemplary modules described. The computer readable medium can be a machine-readable storage device, a machine-readable storage substrate, a memory device, a composition of matter effecting a machine-readable propagated signal, or a combination of one or more them. The term “data processing apparatus” encompasses all apparatus, devices, and machines for processing data, including by way of example a programmable processor, a computer, or multiple processors or computers. The apparatus can include, in addition to hardware, code that creates an execution environment for the computer program in question, e.g., code that constitutes processor firmware, a protocol stack, a database management system, an operating system, or a combination of one or more of them. A propagated signal is an artificially generated signal, e.g., a machine-generated electrical, optical, or electromagnetic signal, that is generated to encode information for transmission to suitable receiver apparatus.

While this specification contains many specifics, these should not be construed as limitations on the scope of what may be claimed, but rather as descriptions of features specific to particular implementations of the subject matter. Certain features that are described in this specification in the context of separate embodiments can also be implemented in combination in a single embodiment. Conversely, various features that are described in the context of a single embodiment can also be implemented in multiple embodiments separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system components in the embodiments described above should not be understood as requiring such separation in all embodiments, and it should be understood that the described program components and systems can generally be integrated together in a single software product or packaged into multiple software products.

The subject matter of this specification has been described in terms of particular embodiments, but other embodiments can be implemented and are within the scope of the following claims. For example, the actions recited in the claims can be performed in a different order and still achieve desirable results. As one example, the processes depicted in the accompanying figures do not necessarily require the particular order shown, or sequential order, to achieve desirable results. In certain implementations, multitasking and parallel processing may be advantageous. Other variations are within the scope of the following claims.

What is claimed is:

1. A method comprising:
initializing a backup process on a device;
performing an initial backup for the device including storing data from the device on a first storage device, where the stored data has a format corresponding to a file system structure of the device.

2. The method of claim 1, further comprising:
performing an incremental backup including:
identifying changed data on the device from the initial backup; and
storing the changed data and data representing a current file system hierarchy of the backup data, where the data representing the current file system hierarchy includes links to data of the initial backup.

3. The method of claim 1, where initializing a backup process further comprises:
loading the backup process at system startup; and
running the backup process continuously as a background process.

4. The method of claim 1, where performing an initial backup includes identifying one or more storage devices for storing the initial backup.

5. The method of claim 2, where identifying changed data further comprises:
monitoring for events indicating a change to data on the device.

6. The method of claim 2, where identifying changed data further comprises:
comparing data on the device with the data of the initial backup.

7. The method of claim 2, where identifying changed data further comprises:
identifying a change according to one or more rules defining change events.

8. The method of claim 2, where performing the incremental backup further comprises:
monitoring system resources identifying system inactivity; and
initiating the incremental backup when system inactivity is identified.

9. The method of claim 2, where the incremental backup is performed according to a schedule.

10. The method of claim 2, where the incremental backup is performed in response to a change in data on the device.

11. A system comprising:
means for initializing a backup process on a device; and
means for performing an initial backup for the device including storing data from the device on a first storage device, where the stored data has a format corresponding to a file system structure of the device.

12. The system of claim 11, further comprising:
means for performing an incremental backup including:
identifying changed data on the device from the initial backup; and
storing the changed data and data representing a current file system hierarchy of the backup data, where the data representing the current file system hierarchy includes links to data of the initial backup.

13. A system comprising:
a graphical user interface configured to present:
a preferences menu including general preferences and backup device preferences;
the backup device preferences including a destination location for a backup; and
the general preferences including information associated with backup scheduling.

14. The system of claim 13, where the preferences menu includes scheduling preferences for scheduling a backup operation.

15. The system of claim 13, where the general preferences includes a plurality of applications for selection as included in a backup operation.

16. A method comprising:
initiating a backup system;
selecting one or more preferences for backup operations;
performing one or more backup operations according to the identified preferences, the backup operations generating a backup having stored data corresponding to a file system structure.

17. The method of claim 16, where selecting one or more preferences includes selecting one or more applications to be included in the generated backup.

18. The method of claim 16, where selecting one or more preferences includes selecting a schedule for performing the backup operations.

19. The method of claim 16, where selecting one or more preferences includes selecting a particular storage device of one or more storage devices to store the generated backup.

20. The method of claim 19, where the one or more storage devices are external storage devices.

21. The method of claim 19, where a storage device of the one or more storage devices is a remote storage device.

22. The method of claim 16, where the file system structure of the stored backup is a hierarchical file system.

23. A method comprising:
defining one or more criteria for capturing a state of a view of a user interface;
using a backup daemon to capture the state of the view in accordance with the criteria;
storing a captured view on an external storage device;
receiving a prompt to suspend presentation of a current view and present the captured view; and
reinstating the captured view into the current view of the user interface.
